(19) United States
(12) Patent Application Publication
(10) Pub. No.: US 2003/0221058 A1
(43) Pub. Date: Nov. 27, 2003

(54) Mirrored computer memory on single bus

(76) Inventors: Eric M. Rentschler, Fort Collins, CO (US); Michael Kennard Tayler, Loveland, CO (US)

Correspondence Address: HEWLETT-PACKARD COMPANY, Intelletual Property Administration, P.O. Box 272400, Fort Collins, CO, 80527-2400, US

(21) Appl. No.: 10/154,648

(22) Filed: May 22, 2002

(51) Int. Cl. G06F 12/16; G06F 12/00

(52) U.S. Cl. 711/114; 711/154

(57) ABSTRACT

A fully mirrored memory system includes mirror memory on the same memory bus as the active memory. Data is written to both active memory and mirror memory. Select-signal lines are used to control which memory units are used for writing and reading. If a memory unit is determined to be defective, the signal-select lines are used to logically replace the active memory unit with its corresponding mirror memory unit for reading.

### FIELD OF INVENTION

This invention relates generally to computer memory systems.

### BACKGROUND OF THE INVENTION

For mission-critical computer systems, one key operational parameter is availability. If parts of a system fail, the system should continue to be available, preferably with no reduction in performance.

It is known to provide spare memory modules, with a way to automatically substitute a working module for a defective module. See, for example, U.S. Pat. No. 4,093,985. Typically, because of the cost of memory, the amount of memory used as spare memory is much less than the amount of memory actively being used. As a result, when errors are detected in a defective memory unit, the contents of the defective unit must be copied to the spare memory before the defective unit is inactivated. Depending on the size of the defective unit, copying the contents may affect performance.

Where both availability and full performance are critical, it is known to provide two completely separate redundant memory systems with identical data contents. If errors in one of the systems exceed a predetermined threshold, the system with errors may be inactivated and the other memory system may be activated, with little or no impact on performance. Such systems are called mirrored memory systems. If memory modules can be replaced while the overall computer system is running, replacement is sometimes called hot swapping, or hot plugging.

FIG. 1 illustrates a mirrored memory system with two separate controllers and two separate memory busses. A processor 100 communicates over a processor bus to two memory controllers 102 and 104. Controller 102 controls a first memory bus A. Controller 104 controls a second memory bus B. Two memory units, AO and A1 are illustrated on memory bus A. Two memory units, B0 and B1 are illustrated on memory bus B. In the configuration illustrated in FIG. 1, controllers 102 and 104 operate in parallel. Whatever is written to memory unit A0 is also written to memory unit B0. Whatever is written to memory unit A1 is also written to memory unit B1. Memory read transactions only use one memory bus. For example, if memory bus A is active, then memory bus B is not used for memory read transactions. If, for example, memory bus A is active, and memory unit A1 is determined to be defective (for example, correctable memory errors), memory read transactions may be switched from memory bus A to memory bus B. Power to memory bus A may be disconnected, and an entire bank of memory containing memory unit A1 may be removed and replaced, with no interruption of service or impact on performance. After memory unit A1 is replaced, data in memory unit B1 is copied to replacement unit A1 for full mirroring. This copying of data may be performed as a background process without affecting performance.

Mirrored memory systems typically duplicate complex and expensive memory controllers and memory busses. There is a need for less expensive and less complex mirrored memory systems.

### SUMMARY OF THE INVENTION

A fully mirrored memory system includes mirror memory on the same memory bus as the active memory. Data is written to both active memory and mirror memory. Data is read from only the active memory. Select-signal lines are used to control which memory units are used during memory writing and reading.

### BRIEF DESCRIPTION OF THE DRAWINGS

FIG. 1 is a block diagram illustrating a prior art mirrored memory system.

FIG. 2 is a block diagram illustrating an example embodiment of a mirrored memory system in accordance with the invention.

### DETAILED DESCRIPTION OF THE PREFERRED EMBODIMENT OF THE INVENTION

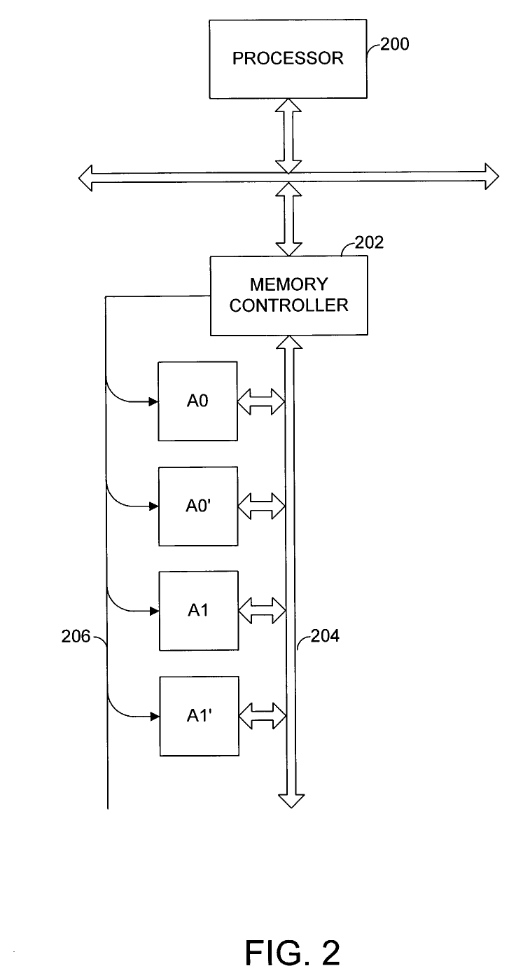

FIG. 2 illustrates an example embodiment of the invention. In the configuration of FIG. 2, a processor 200 communicates with a memory controller 202, which in turn controls a memory bus 204. In the example, four of an arbitrary number of memory units (A0, A0′, A1, A1′) are connected to memory bus 204. Memory on memory bus 204 is fully mirrored. That is, data is written to at least two different memory units. Data is read from only one memory unit. Active and mirror memory units are on the same memory bus. For example, memory writes to memory unit A0 may also be written to memory unit A0′, and memory writes to memory unit A1 may be also be written to memory unit A1′. For memory read transactions, only one of units A0 and A0′ is used, and only one of units A1 and A1′ is used. Select-signal lines 206 are used to control which memory units are used for writing and reading.

In typical commercially available memory circuits, memory units are connected in parallel to all data signals and most control signals on a memory bus, and there is a separate signal for each memory unit that controls whether the memory unit responds to the memory bus signals. In many commercially available circuits, the separate control signal is called Chip-Select. However, the term “select-signal” is intended to include any signal, including Chip-Select, that can control whether a memory unit responds to a memory bus transaction.

The term “memory unit” refers to any amount of memory that can be logically controlled (enabled or disabled) by the select-signal lines. A memory unit may or may not correspond to a physical module or assembly.

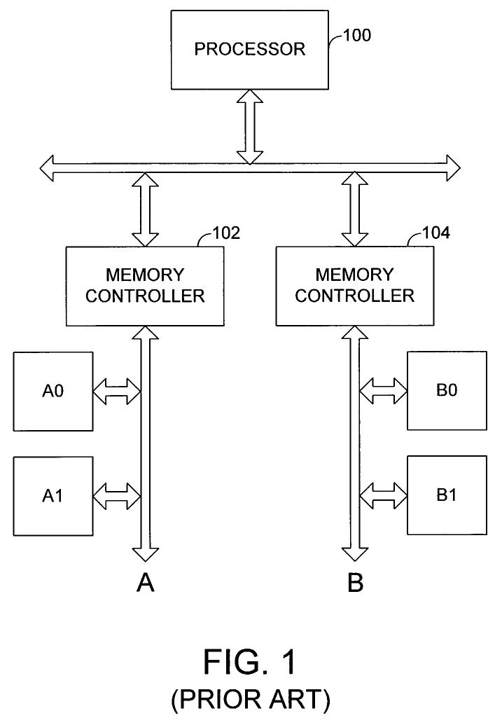

Comparing the system of FIG. 2 to FIG. 1, the system of FIG. 2 provides full mirroring with only a nominal amount of incremental control circuitry. The only incremental control circuitry is a change to the signal-select control lines. Signal-select control lines, such as Chip Select, are required even without mirroring. In the system of FIG. 2, the signal-select control lines are used to select two memory units for each write transaction instead of one memory unit, and are used to select one of two memory units for reading, each of which requires very little incremental logic compared to mirroring across separate memory busses. Other than select-signal control line logic, the rest of the controller and memory bus may be unchanged. The resulting system provides full mirroring with one memory controller, one memory bus, and very little incremental control circuitry.

In the system of FIG. 2, if one memory unit is determined to be defective, memory read transactions may be switched to a corresponding mirror unit. For example, if memory unit A0 is defective, memory read transactions for A0 may be switched to memory unit A0′ by using the select-signal control lines 206. Alternatively, active and mirror memory units may be physically separate memory banks. For example, memory units A0 and A1 may be physically mounted on one printed circuit assembly, and memory units A0′ and A1′ may be physically mounted on a separate printed circuit assembly. If, for example, memory unit A0 is determined to be defective, then the select-signal control lines 206 may be used to switch memory read transactions from memory units A0 and A1 to memory units A0′ and A1′.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A computer system, comprising:
a memory bus;
at least one first memory unit coupled to the memory bus;
at least one second memory unit coupled to the memory bus;
where each data written to the first memory unit is also written to the second memory unit; and
where at most one of the first memory unit and the second memory unit responds to memory read transactions.

2. The computer system of claim 1, further comprising:
a memory controller;
select-signal control lines from the memory controller to the first memory unit and the second memory unit; and
where the select-signal control lines select the first memory unit and the second memory unit to respond to a memory write transaction.

3. The computer system of claim 2, further comprising:
where the select-signal control lines select one of the first memory unit and the second memory unit to respond to a memory read transaction.

4. A computer system, comprising:
a memory bus;
a plurality of first memory units coupled to the memory bus;
a plurality of second memory units coupled to the memory bus, where there is a one-to-one correspondence between first memory units and second memory units;
where each data is written to both a first memory unit and to a corresponding second memory unit; and
where at most one of a first memory unit and its corresponding second memory unit responds to memory read transactions.

5. The computer system of claim 4, further comprising:
a memory controller;
select-signal control lines from the memory controller to the first memory units and the second memory units; and
where the select-signal control lines select a first memory unit and its corresponding second memory unit to respond to a memory write transaction.

6. The computer system of claim 5, further comprising:
where the select-signal control lines select one of the first memory unit and its corresponding second memory unit to respond to a memory read transaction.

7. A computer system, comprising:
a memory bus;
means for mirroring all active memory on the memory bus with mirror memory on the memory bus.

8. A method, comprising:
storing data in a first memory unit on a memory bus;
storing the data in a second memory unit on the memory bus;
receiving a memory read transaction for the data; and
selecting one of the first and second memory units to provide the data.

9. The method of claim 8, further comprising:
determining that the second memory unit is defective; and
selecting the first memory unit to provide the data.

10. The method of claim 8, further comprising:
using select-signal control lines to select the first and second memory units for writing.

11. The method of claim 8, further comprising:
using select-signal control lines to select one of the first and second memory units to provide the data.
